(19) United States
(12) Patent Application Publication
(10) Pub. No.: US 2003/0069737 A1
(43) Pub. Date: Apr. 10, 2003

(54) Hierarchical rule determination system

(75) Inventors: Dmitri Koubenski, Cupertino, CA (US); Stayton D. Addison JR., San Jose, CA (US); Daniel Kuokka, Palo Alto, CA (US)

Correspondence Address: HOGAN & HARTSON LLP, ONE TABOR CENTER, SUITE 1500, 1200 SEVENTEEN ST., DENVER, CO, 80202, US

(73) Assignee: Netscape Communications Corporation

(21) Appl. No.: 09/969,635

(22) Filed: Oct. 4, 2001

(51) Int. Cl. G06F 17/60

(52) U.S. Cl. 705/1

(57) ABSTRACT

A system and method for dynamically determining applicable rule instances and a rule value utilizing a hierarchical context, hierarchically specified ruled with inheritance, and a hierarchically relevant conflict resolution strategy. The system includes a context provider, an attribute data store, and a rules engine. The context provider is configured to provide a context comprising an application configuration parameter and the set of context attribute values. The attribute data store has a hierarchical structure and is configured to provide a set of hierarchically relevant context attribute values, based on the set of context attribute values. The attribute data store is designed to permit the clear specification of rules and their applicability conditions. The rules engine is configured to resolve the set of context attribute values with the attribute data store in accordance with the context from the context provider, and to determine a rule value, based on the hierarchically relevant context attribute values from the attribute data store after applying a hierarchical conflict resolution strategy.

### BACKGROUND OF THE INVENTION

1. Field of the Invention

The present invention relates to a system and method for dynamically specifying and determining a set of relevant rule instances in an application context with hierarchical data having implied inheritance, and, more particularly, to a system and method for dynamically determining a set of relevant rules for a general class of e-commerce applications.

2. Discussion of the Related Art

A number of conventional systems and methods are available for determining a rule instance applicable to a data context, or a working memory. These systems use implicit techniques, such as selecting the simplest rule or the highest priority rule. However, these systems and methods have shortcomings, such as not giving the maintainer full control over rule selection, not supporting applications with hierarchical data, and not providing for a robust inheritance model.

The data store also may be known as the rule base or attribute data store.

Due to these limitations, conventional rule systems have not been applied successfully to e-commerce applications, or to other applications wherein the selection of the rule and behavior of the system should be predictable.

### SUMMARY OF THE INVENTION

Accordingly, a hierarchical rule determination system and method is disclosed that obviates one or more of the problems due to limitations and disadvantages of the related art. A hierarchical rules engine is disclosed that alleviates the problems identified in the discussion of related art by giving the maintainer a powerful, hierarchical model to define rules and their applicability with clear control.

In one embodiment, a system and method is disclosed for dynamically determining a set of relevant rule instances, or rules, given a set of context attribute values from a hierarchically-specified rule data store specifying inheritance relationships using conflict resolution consistent with the inheritance principles. The data store also may be known as the rule base or attribute data store. The system comprises a context provider, a rule data store, and a rules engine. The context provider provides the dynamic state of the application comprising an application configuration parameter, such as the desired output from the rule system and the set of context attribute values, such as inputs to the system. The data store is a repository of rule instances triggered by applicability conditions specified in terms of the hierarchical domains of the context attribute values. The rules engine receives a context from the context provider examines the attribute data store to determine the appropriate hierarchically relevant rule instance, uses a set of hierarchically consistent conflict resolution strategies, and returns to the context provider an appropriate value for the application configuration parameters.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 shows a diagram of a hierarchical rule determination system in accordance with the present invention;

FIG. 2 shows a diagram of three specific, expository hierarchical data stores: a buyer tee, a seller tree, and an object tree with operational identifiers;

FIG. 3 shows a diagram of three generalized data stores;

FIG. 4 shows a flow chart of a hierarchical rule determination method in accordance with the present invention;

FIG. 5 shows a flow chart for the conflict resolution rules phase of the determination process in accordance with the present invention; and

FIG. 6 shows a diagram of a set of example rules specified in the data store in accordance with the present invention.

### DETAILED DESCRIPTION OF THE PREFERRED EMBODIMENTS

Reference will now be made in detail to a first embodiment of the present invention, examples of which are illustrated in the drawings.

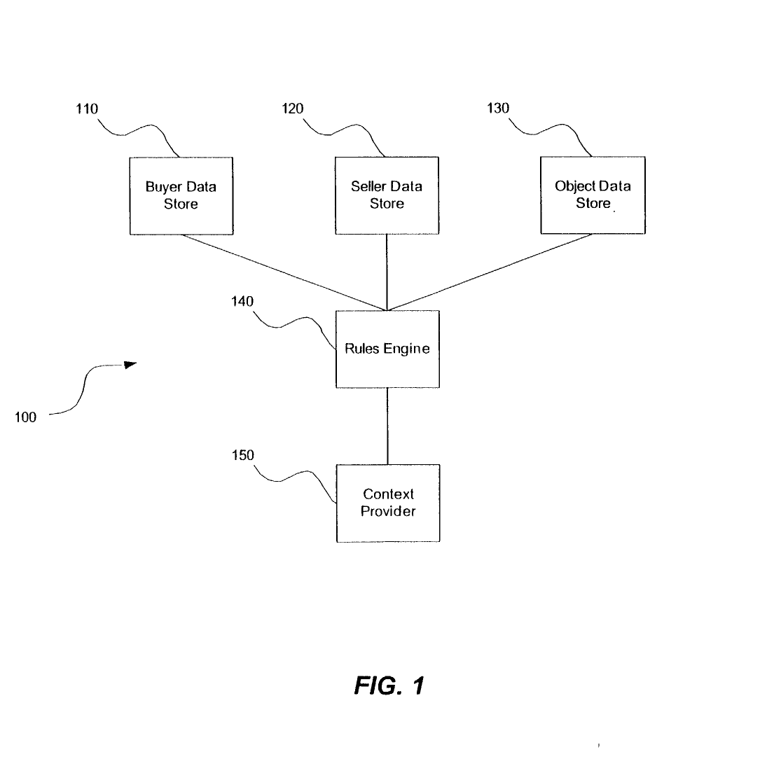

In an embodiment, the hierarchical rule determination system determines a rule instance for a received context. For example, the hierarchical rule determination system may determine a discount application configuration parameter (“ACP”) for an item based on a received context, wherein the context includes a buyer identity, a seller identity, and an item identity. To implement this and other functions, hierarchical rule determination system 100 may be configured as shown in FIG. 1. In this embodiment, hierarchical rule determination system 100 comprises an application data store, or rule base, with a plurality of hierarchies. For the purpose of providing an example by which to explain the present invention, three instances of hierarchies stores have been selected: buyer data store 110, seller data store 120, and object data store 130. It is understood that different instances of data store hierarchies and different numbers of data store hierarchies may be used.

Each of these data store hierarchies, or an arbitrary subset of the data store hierarchies, such as a subset, may be managed by operationally independent organizations, such as a service-provider organization and a client organization. Additionally, each of these data store hierarchies may be managed by an organization approved by the buyer and seller to manage rule instances. In one embodiment, each of the data stores may be implemented as a directed acyclic graph. Additionally, dynamic rule determination system 100 includes rules engine 140 and context provider 150.

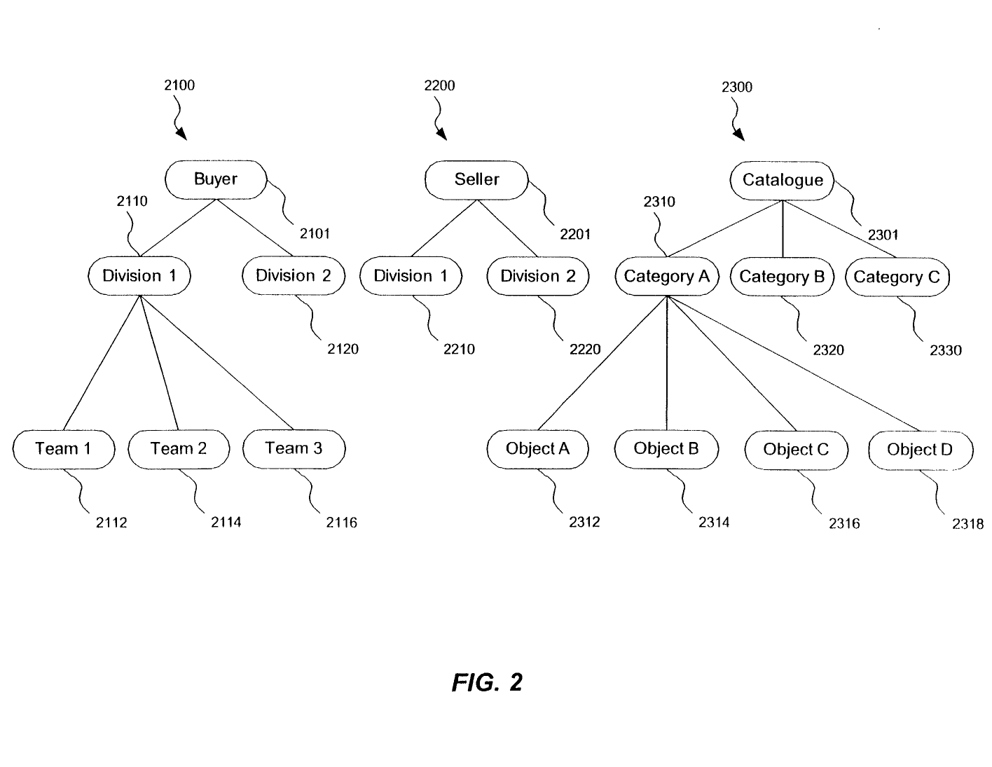

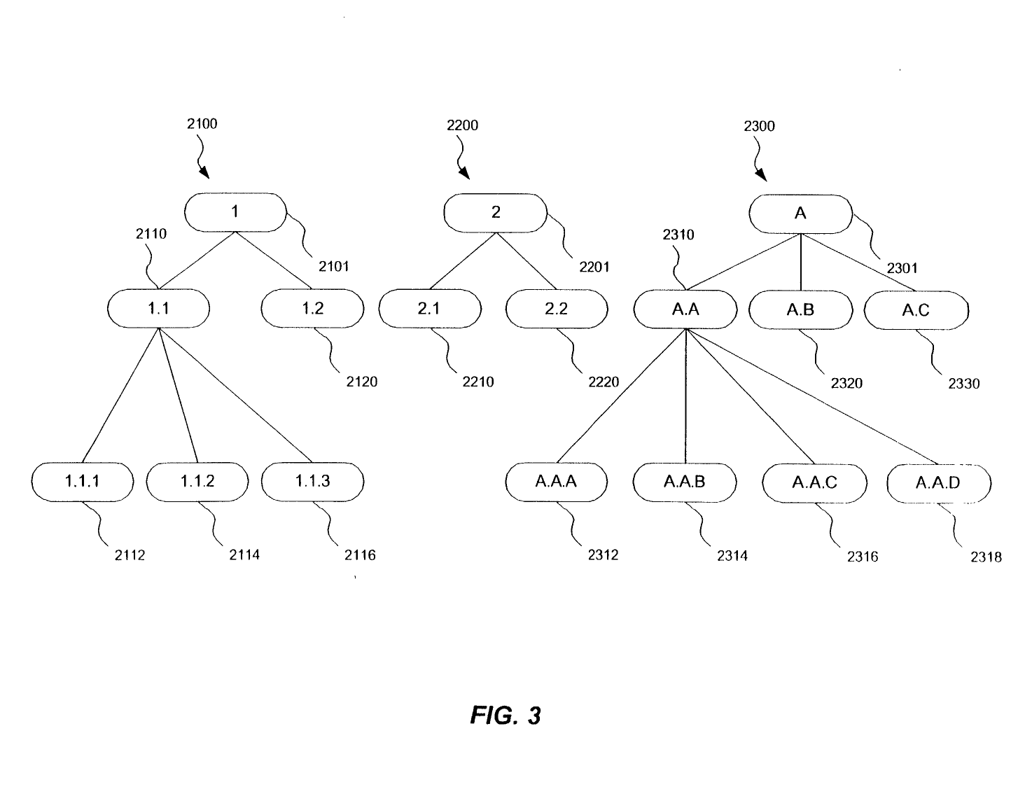

Data store hierarchies 110, 120 and 130, alternatively referred to as attribute data store or rule base, comprise hierarchically structured data stores as shown in FIGS. 2 and 3. In one embodiment, data store hierarchies 110, 120 and 130 are configured to represent the set of context attribute values that may comprise a buyer identity, a seller identity, and an item identity. Based on these received context attributes, data store hierarchies 110, 120, 130 may be used by the rules engine to determine a set of hierarchically relevant context attribute values. For example, as disclosed in greater detail below, if a first context attribute value is received, the rules engine may examine the data store, determine the ancestors of the received context attribute value, determine the applicable rule instance and provide a hierarchically relevant application configuration parameter to the context provider.

Rules engine 140 is configured to receive a context from a context provider, such as context provider 150. Additionally, rules engine 140 examines the data store to determine the applicable rule instance based on the received values. For example, rules engine 140 receives a buyer context attribute value existing within buyer data store hierarchy 110, a seller context attribute value existing within seller data store hierarchy 120, and an object, or product, context attribute value existing within an object data store hierarchy 130. Next, rules engine 140 determines the rule instance applicable to the three received attribute values by locating a rule instance whose applicability condition is equal to or an ancestor of the received context attribute values. The rule instance may be used to determine the value of the ACP for output from the rules engine.

Context provider 150 may comprise an application, process, service or other resource that provides a context. In one embodiment, context provider 150 also may receive an ACP value from the rules engine 140 based on the provided context. In one embodiment, context provider 150 comprises an electronic commerce application. Context provider 150 and rules engine 140 may be physically remote or may be co-located. Rules engine 140 and context provider 150 also may be implemented on a single machine. The communication paths between each of the components of FIG. 1 may be any suitable physical or logical communication channels, paths or methods, including a system bus, a network connection, and a wireless connection.

FIG. 2 shows a diagram of a buyer tree, a seller tree, and an object tree with operational identifiers. Specifically, FIG. 2 shows buyer organization chart 2100, seller organization chart 2200, and object catalogue 2300. Trees 2100, 2200 and 2300 may be represented, for example, in an LDAP server, in a relational database, an XML document, or in another type of hierarchical data structure. Additionally, trees 2100, 2200 and 2300 may be generated dynamically when a context is received by rules engine 140.

For example, buyer organization chart 2100 depicts an organization for Buyer 2101. Buyer 2101 has two divisions, Division (1) 2110 and Division (2) 2120. Division (1) 2110 has three teams 2112, 2114, and 2116. Additionally, some or all of the teams may have individuals associated with the team (not shown). Similarly, Division (2) 2120 may have additional teams, individuals, or other nodes and/or leafs, (not shown). In one embodiment, buyer organization chart 2100 is managed entirely by Buyer 2101, such that a system receives updates to buyer organization chart 2100 from Buyer 2101. Similarly, seller organization chart 2200 is managed entirely by Seller 2201, such that a system receives updates to seller organization chart 2100 from Seller. Additionally, object catalogue 2300 may be managed by Seller 2200. However, as noted above, object catalogue 2300 may be managed by an organization other than Seller 2200.

In one embodiment, a context between a buyer and a seller for a particular object may invoke one or more hierarchically broader rule instances. Rule instances may represent agreements made between a buyer and seller relating to an object, access rights provided by an administrator, or other type of sale. For example, rule instance may establish a rebate available to a buyer when a particular object is purchased from a seller. Because buyers, sellers, and objects may have several nodes and leaves as show in FIG. 2, rule instances may be created and managed for some or all of these nodes and leaves in accordance with the present invention.

In one embodiment, rule instance data store may be stored in rules engine 140. Additionally, rule instance data store may be stored elsewhere in system 100 and transmitted to rules engine 140 when a context is received. The dynamic rule determination system 100 may contain a plurality of rules relating to different context attribute combinations. For example, organization 1 may have rule instances established with organizations 2 and 3, and organization 2 may have rule instances established with organizations 1, 3 and 4.

In one embodiment, a context may invoke rule instances matching the context, and one or more hierarchically broader rule instances. In one embodiment, all matching and hierarchically broader rule instances may apply to a received context. For example, a context between Team (1) 2112 and Division (2) 2220 for Object (C) 2316 may invoke a hierarchically broader rule instance between Division (1) 2110 and Division (2) 2220 for any object in Category (A) 2310. The broadest rule instance for the hierarchies depicting in FIG. 2 is between Buyer 2101, Seller 2200, and Catalogue 2300.

FIG. 3 shows a block diagram of a buyer tree, a seller tree, and an object tree with unique identifiers. These trees may be modified in structure and number, and the entities represented by the trees may be modified as well. In one embodiment, each organization has a global unique identifier within the system. These unique identifiers may be managed by the manager of rules engine 140, by a third party, such as Data Universal Numbering System (“DUNS”), by a combination thereof or by any method that uniquely identifies an organization. The system also may associate a unique identifier with organizations other than individual companies, such as associations, joint ventures, all buyers (e.g., a unique identifier to indicate that a rule is relevant to all buyers), or other organizations. Additionally, each operational limit of an organization may be assigned a local unique identifier which may be used in conjunction with unique identifier of the organization. Similarly, objects in object catalogue 2300 preferably have unique identifiers that identify the object independent of the company that makes the product and/or provides the service. Examples of such unique identifiers are Universal Product Codes (“UPC”) and International Standard Book Numbers (“ISBN”). Additionally, the system may create its own unique identification system, as depicted in FIG. 3.

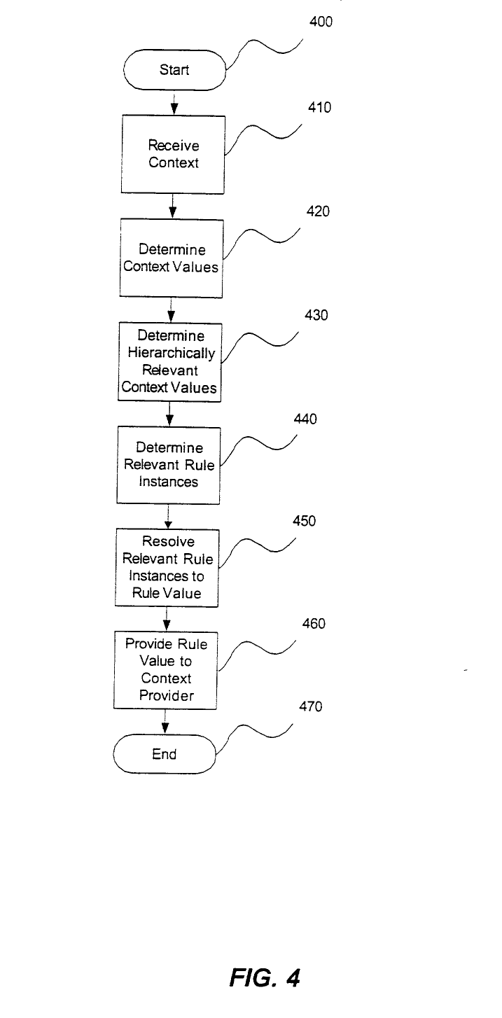

FIG. 4 shows a flow chart of a dynamic pricing method in accordance with the present invention. In overview, the process is initiated at step 400. At step 410, a context is received. At step 420, the rules engine determines context values for the received context. At step 430, the rules engine determines hierarchically relevant context values for the received context by examining the hierarchies in the data store. At step 440, the rules engine determines relevant rule instances by examining the data store. At step 450, the rules engine resolves relevant rule instances to a rule value. At step 460, the rules engine provides the rule value to the context provider. The process terminates at step 470. Each of these steps is described in greater detail below.

At step 410, a context is received. This context may be received by rules engine. In one embodiment, the rules engine receives a context from an electronic commerce application. For example, returning to the example of a system comprising a buyer, seller and object data store, the rules engine may receive a context comprising an application configuration parameter, a buyer attribute, a seller attribute, and an object attribute. This context could be generated when a buyer has requested an object from a seller. For example, a member of Team 1 from Division 1 of Buyer may be purchasing one Object (e.g., A.A.C) from Division 1 of Seller. This transaction may be represented by the context Buyer==1.1.1&Seller==2.1&Object==A.A.C==>Discount.

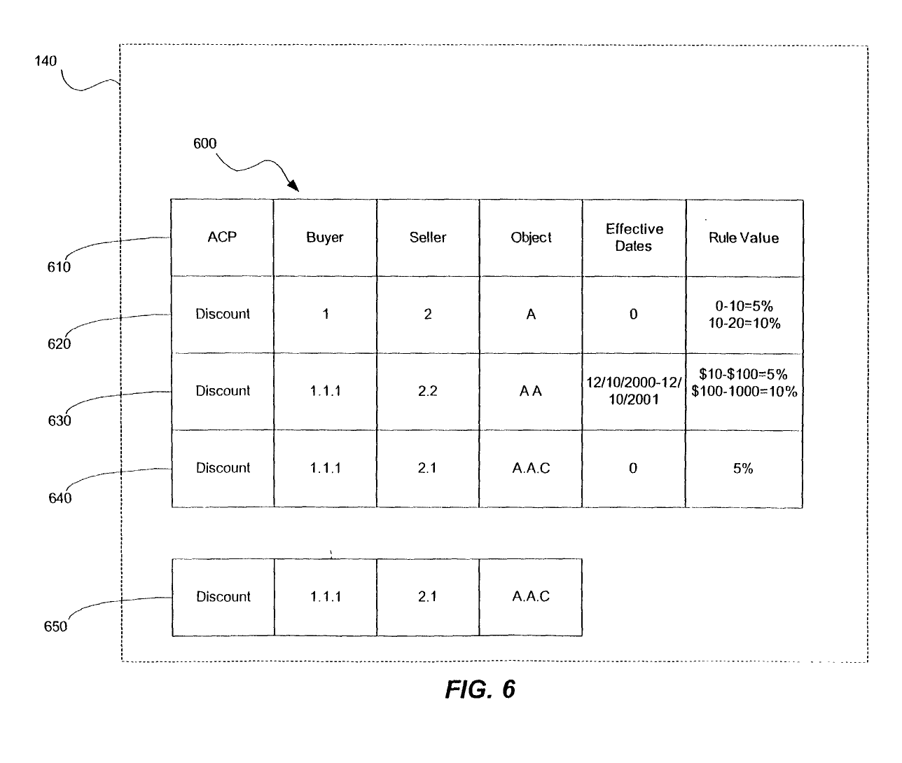

In one embodiment, the received context may include other information. For example, the context may include a number of objects involved in the context, an aggregate value of objects, a combination thereof, or other information. This other information may comprise a fixed quantity, such as 100, or a determinable quantity, such as 100 objects if the cost per object is $100 or greater, 200 objects if the cost per object is less than $100. For an example of a possible physical and/or logical structure of a received context, see received context 650 of FIG. 6. A context may be received as a recordset, an XML document, or by other data communication methodology.

At step 420, the rules engine determines context values for the received context. Using the above example, the rules engine may determine that the attributes for the context Buyer==1.1.1&Seller==2.1&Object==A.A.C==>Discount are ‘1.1.1,’ ‘2.1,’ ‘A.A.C,’ and ‘Discount’ for buyer, seller, object, and ACP, respectively.

These context attribute values are compared to their respective data store hierarchies at step 430 in order to determine hierarchically relevant context values for the received context. For example, as shown in FIG. 3, 1.1.1 is a leaf of node 1.1, and 1.1 is a leaf of node 1. Accordingly, buyer data store hierarchy 110 and rules engine 140 may determine that 1.1.1, 1.1 and 1 are hierarchically relevant context values. In addition to determining the buyer, seller, and object identities, the rules engine may determine other context parameters that are used in determining an ACP value, such as an object base price.

At step 440, the rules engine determines relevant rule instances. In one embodiment, all matching and hierarchically broader rule instances are relevant rules. A hierarchically broader rule is any rule that has attribute values that are in the set of hierarchically relevant context values, as determined in step 430. In the present example, each of the following rules would be relevant as hierarchically broader rule instances:

1.1.1, 2.1, A.A.C=Received Context

1.1, 2.1, A.A.C=Broader (Parent of 1.1.1)

1, 2.1, A.A.C=Broader (Grandparent of 1.1.1)

1.1.1, 2, A.A.C=Broader (Parent of 2.1)

1.1.1, 2.1, A.A=Broader (Parent of A.A.C)

1, 2, A=Broadest Rule (Grandparent of 1.1.1 and A.A.C, Parent of 2.1)

Additional, unlisted, hierarchically broader rules may exist. In addition to filtering rules based on hierarchically relevant context values, other parameters may be used. For example, if the context has an effective date value, the rules engine may filter out all those rules in which the received context does not satisfy the effective date criteria.

In one embodiment, all rule instances are stored in a rules data store that may be integral with or remote from rules engine 140. The rules data store may comprise a particular type of rule, such as a plurality of discount rules or comprise a plurality of different types of rules, such as a plurality of discount rules, access rules, spending limit rules, other rules. In one embodiment, the rules engine may retrieve all rules relating to a relevant buyer and a relevant seller from a rules data store and perform additional rules analysis in memory, thereby reducing the number of database accesses.

FIG. 6 provides an exemplary logical representation of rules data store 600. Rules data store 600 may comprise a plurality of rule instances 620, 630 and 640. These rules may identify the parameters by which a particular rule instances is determined to be relevant. For instance, using the example above, rule instances 620 and 640 may be relevant to received context 650, while rule instance 630 may be not relevant. Specifically, rule instance 640 is relevant because the received context buyer, seller, and object identity are equal to the rule instance 640 buyer, seller, and object identity. Rule instance 620 is relevant because rule 620 is a hierarchically broader rule than rule instance 640 (1 is the grandparent of 1.1.1, 2 is the parent of 2.1, and A is the grandparent of A.A.C). Rule instance 630 is irrelevant because rule instance 630 is not hierarchically broader than rule instance 640 (2.2 is the sibling of 2.1).

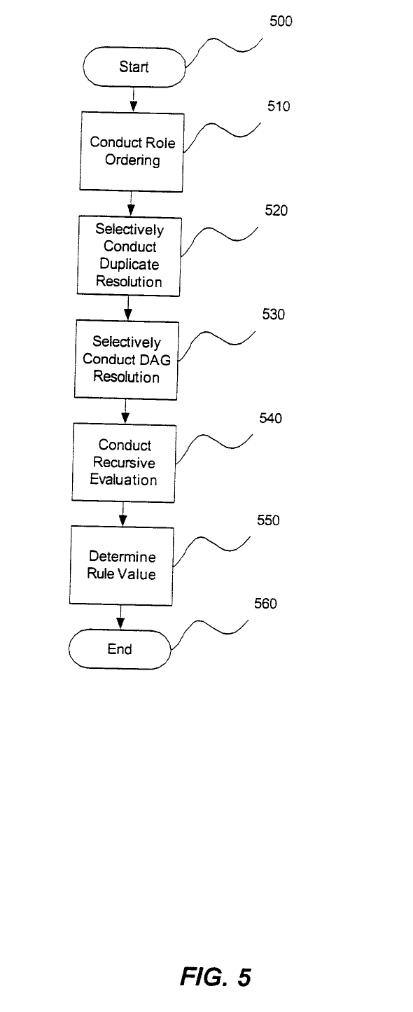

At step 450, the rules engine resolves relevant rule instances to a rule value. In one embodiment, this step may be implemented in accordance with the process disclosed in relation to FIG. 5 below.

At step 460, the rules engine provides the rule value to the context provider. For example, the rules engine may provide a discount to an electronic commerce application, an access approval indicator to an access control program, a winner to a complex auction program, or provide a rule value to another type of context provider. The rules engine may additionally perform other tasks, such as caching a rule value for a received context.

FIG. 5 shows a flow chart of a process in accordance with the present invention. Specifically, FIG. 5 shows a process in accordance with the present invention in which the rules engine resolves multiple relevant rules to a single value. Specifically, the process is initiated at step 500. At step 510, the rules engine conducts role ordering based on static role ordering. At step 520, the rules engine selectively conducts duplicate resolution based on a duplicate resolution strategy. At step 530, the rules engine selectively conducts directed acyclic graph (“DAG”) resolution based on a DAG conflict resolution strategy. At step 540, rules engine conducts recursive evaluation. At step 550, rules engine determines rule value. The process terminates at step 560.

At step 510, the rules engine conducts role ordering based on static role ordering. In one embodiment, there is a total ordering for roles for a given rule name. Conflicts between applicable rules may be resolved for the first role, first. If there are multiple rules with identical values for the first role, then the second role will be used to resolve the conflict, and so on for subsequent roles. This resolves conflicts that cross inheritance trees. For example, assume there are two roles with the following ordering: buyer and product. Further assume these two rules:

Buyer==Netscape & Product==All =>Discount=5%

Buyer==Netscape & Product==Computers =>Discount=10%

If a buyer within Netscape wants to purchase a computer, both rules apply. Since the first role (Buyer) is identical for both rules, the conflict between rules will be resolved by the second role (Product). If the first role (Buyer) for the 5% rule had been APD, then that role would be used to resolve the conflict since Buyer precedes Product. Given the Role Ordering resolution phase, subsequent conflict resolution can occur within a single role, and therefore a single inheritance hierarchy.

At step 520, the rules engine selectively conducts duplicate resolution based on a duplicate resolution strategy. In one embodiment, if there are multiple rules with identical applicability conditions, then the conflict resolution algorithm will apply the Duplicate resolution strategy associated with each rule globally.

For example, assume there are two rules as follows:

Product==Computers=>Discount=10%

Product==Computers=>Discount=5%

Since the applicability conditions of these rules is identical, there are duplicate values for discount which cannot be decided on the basis of the applicability conditions alone.

At step 530, the rules engine selectively conducts DAG resolution based on a DAG conflict resolution strategy. If the inheritance tree for a role is actually a DAG, then there is no clear ordering of rules specified for siblings. In this case, the conflict resolution algorithm will apply the DAG resolution strategy associated with each rule globally (i.e., with all instances of the rule). For example, assume there are two rules as follows:

Product==Computers=>Discount=10%

Product==Domesticltems=>Discount=5%

The received context relates to the purchase of a domestic computer. In this situation, there is no way to determine which rule should be preferred. For Discounts, it is likely that the configuration parameter will be set to “union”, and therefore all applicable rule values will be returned. The rules engine may be configured to take any action. In one embodiment, all discounts will be applied and some other limiting mechanism will be used to avoid excessive discounts such as MaxDiscount rule.

As another example, consider the following rules:

Buyer==Netscape/APD=>MaxPurchase=$100

Buyer==Netscape/Admins=>MaxPurchase=$100000

Further, assume that the buyer is organizationally in APD but also belongs to the Admins group. Unlike the above example, however, it may be desirable for this conflict to signal an error since it is not acceptable for a buyer to use his Admin spending limit for purchases outside the scope of the Admin function.

Values for the duplicate and DAG resolution strategy include Max, Min, Intersection, Union, Bag, Error, and MostRecent. Additional duplicate and DAG resolution strategies may be included in the process. The semantics of these strategies may be known to those skilled in the art. For example, “Max” may take the maximum of the conflicting rule values. Union may return a single instance of all conflicting values contributed by all applicable rules.

At step 540, rhe rules engine conducts recursive evaluation. In one embodiment, a recursive evaluation is an evaluation starting at the lowest node of the hierarchy created after step 530 and recursively evaluating each parent until such continue evaluation reaches the root node or when each parent no longer requires recursive evaluation. An example of the latter situation is when the conflict resolution strategy for all parents is a “Most Specific” resolution strategy, meaning that further evaluation up the inheritance tree is not necessary.

At step 550, the rules engine determines rule values. This rule value may be an aggregate rule value, a set of rule values, a pointer, a script, or other value. Using a discount example, the rule value may be an aggregate discount (15%), a set of discounts (5%, 10%, 15%), a pointer (a discount found at location http://computer/file), a script (5% if quantity ordered is less than 100, else 10%), or other value.

In one embodiment, the present invention may be implemented using object-oriented design patterns and an object oriented programming language. Accordingly, the sequence of acts implemented by the present invention may be modified without departing from the scope of the present invention. By way of specific example, the system may determine which analysis framework is applicable at any time after the context has been received.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A system for dynamically determining relevant rule instances based on a set of context attribute values and a hierarchically organized rule data store, comprising:
a context provider configured to provide a context, said context comprising an application configuration parameter and the set of context attribute values having hierarchically organized domains;
an attribute data store of rule instances having a hierarchical structure configured to specify the relevant rule instances based on the hierarchically organized domains of the context attribute values; and
a rules engine configured to examine the attribute data store based on the set of context attribute values received from the context provider, and to determine the relevant rule instance.

2. The system of claim 1, wherein the hierarchically structured attribute data store comprises a Lightweight Database Application Protocol compliant directory server.

3. The system of claim 1, wherein the rules engine is additionally configured to determine a set of relevant rule values based on the hierarchically relevant rule instance from the rule data store.

4. The system of claim 3, wherein the conflict resolution schemes comprises at least one of a role ordering scheme, a duplicate resolution scheme, a directed acyclic graph scheme, and a DAG resolution scheme.

5. The system of claim 3, wherein the conflict resolution schemes include Maximum, Minimum, Intersection, Union, Bas, Error and MostRecent.

6. The system of claim 1, wherein the context provider comprises an electronic commerce application.

7. The system of claim 1, wherein the rules engine is configured to filter out a rule that has an applicability condition that is not consistent with the set of hierarchically organized context attribute values.

8. A method for dynamically determining a rule instance based on a set of received context attribute values comprising:
determining a set of relevant rule instances, based on the set of hierarchically relevant context values; and
determining the rule value based on the set of relevant rule instances, rule instance values, and the hierarchical rule data store.

9. The method of claim 8, wherein the step determining, based on the set of relevant rule instances, the rule value comprises:
determining an applicable conflict resolution scheme; and
applying the conflict resolution scheme to the relevant rule instances.

10. The method of claim 9, wherein the conflict resolution scheme comprises at least one of a role ordering resolution scheme, a duplicate resolution scheme, and a DAG resolution scheme.

11. The method of claim 9, wherein the conflict resolution schemes include Maximum, Minimum, Intersection, Union, Bag, Error and Most Recent.

12. The method of claim 8, further comprising:
providing the rule to an electronic commerce application.

13. A system for dynamically determining a rule instance and subsequent rule value based on a set of context attribute values comprising:
context provider means configured to provide a context, said context comprising an application configuration parameter and the set of context attribute values;
data store means having a hierarchical structure configured to provide a set of hierarchically relevant context attribute values, based on the set of context attribute values; and
rules engine means configured to resolve the set of context attribute values with the data store means in accordance with the context from the context provider means, and to determine the rule value, based on the hierarchically relevant context attribute values from the attribute data store.

14. A computer program product, comprising a computer readable medium having computer code embodied therein for dynamically determining a rule instance and subsequent rule value based on a set of context attribute values comprising:
computer readable program code devices configured as a context provider;
computer readable program code devices configured as a data store;
computer readable program code devices configured as a rules engine configured to receive a context from a context provider, resolve the set of context with a data store, determine the set of hierarchically relevant rule instances according to inheritance relationships, resolve any conflicting rules, and determine the rule value.
